(19) United States
(12) Patent Application Publication
(10) Pub. No.: US 2014/0266792 A1
(43) Pub. Date: Sep. 18, 2014

(54) UNIVERSAL MONITORING SYSTEM AND MODULAR INTERFACE AND SENSOR ASSEMBLIES

(71) Applicant: Raymond & Lae Engineering, Inc., Fort Collins, CO (US)

(72) Inventor: Donald M. Raymond, Fort Collins, CO (US)

(73) Assignee: Raymond & Lae Engineering, Inc., Fort Collins, CO (US)

(21) Appl. No.: 14/202,113

(22) Filed: Mar. 10, 2014

Related U.S. Application Data
(60) Provisional application No. 61/778,728, filed on Mar. 13, 2013.

(51) Int. Cl. G08C 17/02

(52) U.S. Cl. CPC G08C 17/02
USPC 340/870.11

(57) ABSTRACT

Disclosed is a monitoring system that is capable of monitoring data from sensors using both wired and wireless communication links. A wide variety of sensors can be utilized with various monitoring systems through the use of an interface device that translates the communication protocol of the sensors to the communication protocol of the monitoring device. In this fashion, the sensors can be mass produced at lower prices to reduce the overall cost of the sensors, as well as providing a wide variety of sensors. Interface devices can also be mass produced, which also lowers the overall cost of the sensing system.

### CROSS-REFERENCE TO RELATED APPLICATION

This application is a non-provisional application of U.S. Patent Application Ser. No. 61/778,728, entitled “Universal Monitoring System and Modular Interface and Sensor Assemblies,” filed by Donald M. Raymond on Mar. 13, 2013. The entire contents of the above mentioned application are hereby specifically incorporated herein by reference for all they disclose and teach.

### BACKGROUND

Monitoring systems typically use sensors to detect various environmental conditions and other physical conditions associated with a particular area. For example, monitoring systems can detect the presence of moisture in a building from a leaking pipe, a leaking hot water heater, or other source of water. The presence of water in buildings can result in the growth of black mold and other organic materials that can adversely affect the health and well-being of people living and working in such an environment.

Sensors can also detect, and monitors can track, humidity levels in computer rooms and data centers to ensure that the proper environmental conditions exist in the computer centers and data centers. Computer systems often require humidity and temperature to be carefully controlled in these centers. Further, data can be collected using detectors and monitoring systems so that other factors can be tracked for various other purposes. For example, sensors can be used to count people passing through a particular area. This data can be collected and used for staffing purposes for businesses. Sensors can be used to detect temperature, humidity, pressure, flow, voltage, current, people, UV light, and a very large number of additional conditions. Monitoring systems are capable of detecting, displaying, accumulating, organizing, communicating and providing a historical time-based record of data relating to detected conditions. High level monitoring systems may have color displays with various types of presentations, including bar charts, pie charts, etc. Monitoring systems are capable of generating alarm signals that can be communicated by landlines, cell phones, email, text, pagers, audio alarms and other forms of communication. Monitoring systems and sensors have therefore provided a valuable function in providing important data to users.

### SUMMARY

An embodiment of the invention may comprise a sensor system comprising: at least one sensor that generates a sensor signal using a first predetermined communication protocol; an interface translator that translates the sensor signal from the first predetermined communication protocol to a second communication protocol that is used by a monitoring system.

An embodiment of the invention may further comprise a method of sensing environmental conditions comprising: connecting a plurality of sensors in series that generate a serial sensor signal; transmitting the serial sensor signal to an interface translator; translating the serial sensor signal to a monitor sensor signal that is capable of being read by a monitoring device.

An embodiment of the invention may further comprise a monitoring system comprising: a monitoring device that has at least one wired sensor port that receives signals using a first communication protocol; and a plurality of sensors that are connected in series that generate a serial sensor signal that uses a second communication protocol; a direct wired interface that is connected to the plurality of sensors and the at least one wired sensor port that translates the serial sensor signal from the second communication protocol to the first communication protocol.

An embodiment of the invention may further comprise a monitoring system comprising: a monitoring device; a wireless module that is connected to and communicates with the monitoring device using a first communication protocol, the wireless module having at least one wireless communication port that sends and receives wireless transmissions using the first communication protocol; a plurality of sensors that are connected in series that generate a serial sensor signal using a second communication protocol; a wireless interface that is connected to the plurality of sensors and to the at least one wireless communication port that translates the serial sensor signal from the second communication protocol to the first communication protocol.

An embodiment of the invention may further comprise a method of monitoring sensor signals comprising: connecting a plurality of sensors in series to generate a serial sensor signal having a first communication protocol that identifies serially connected sensors, data generated by each sensor of the serially connected sensors and a type of data that is detected by each the sensor; transmitting the serial sensor signal to an interface translator; translating the serial sensor signal from the first communication protocol to a second communication protocol; transmitting the serial sensor signal having the second communication protocol to a monitoring device that can read the second communication protocol.

### BRIEF DESCRIPTION OF THE DRAWINGS

FIG. 1 is a schematic block diagram of the architecture of an embodiment of a monitoring system.

FIG. 2 is a schematic block diagram of an embodiment of a monitoring device.

FIG. 3 is a schematic block diagram of an embodiment of a monitoring device and wireless module.

FIG. 4 is a schematic block diagram of an embodiment of a monitoring and control communication system.

FIG. 5 is a schematic block diagram of another embodiment of a monitoring and control communication system.

FIG. 6 is a schematic block diagram of an embodiment of a hard wired interface system.

FIG. 7 is a schematic block diagram of an embodiment of a wireless interface system.

FIG. 8 is a schematic block diagram of an embodiment of a sensor.

### DETAILED DESCRIPTION OF THE EMBODIMENTS

FIG. 1 is a schematic block diagram of an embodiment of a monitoring system 100. The monitoring system 100 includes a monitoring device 102 and a wireless module 104. The monitoring device 102 includes a power input 106. USB port 108 is a generalized USB port that allows the communication of data to and from the monitoring device 102, the ability to connect additional storage to the monitoring device 102, as well as other functions. Wired communication ports 110 comprise standard communication ports for receiving and transmitting data through wired connections to the wired communication ports 110. For example, wired communication ports 110 may include an Ethernet port for connecting the monitoring device 102 to the Internet or other networks. Wired communication ports 110 may also include various standard serial protocol ports, such as an RS232 serial port, an RS485 serial port, an EIA-232 craft port, a 4-20 milliamp port, a 0-10 volt port, a 0-5 volt port, a 0-1 volt port, a 0-1 milliamp port, a 0-20 milliamp port, an RS422 port, etc. These ports can be selected in accordance with various communication protocols that are commonly used by other devices that communicate with the monitoring device, including standard computer systems and high level monitoring systems, such as high level monitoring system 152.

As also illustrated in FIG. 1, wired sensor ports 112 are connected to the direct wired interface 118, which, in turn, is connected to sensors 124, via wire 122. As explained in more detail below, the direct wired interface 118 provides an interface between a standard set of sensors 124 that transmit sensor data to the direct wired interface 118 using a preselected protocol. The pre-selected protocol may be 1-wire protocol, I²C protocol, one of the standard UART protocols, a PWM protocol, or other protocol. The direct wired interface 118 is designed to transform the sensor data from wire 122 into a protocol that matches the protocol of the wired sensor ports 118. The protocol of the wired sensor ports 112 may be any one of a number of different protocols, including USB, Ethernet, RS485, RS232, 4-20 milliamps, 0-10 volts, 0-5 volts, 0-1 volts, 0-1 milliamp, 0-20 milliamp, frequency based inputs, pulse width modulation protocol, I²C, SPI, 1-wire, and other protocols. In that manner, the direct wired interface 118 allows the use of a wide variety of inexpensive sensors 124 to be connected to monitoring devices, such as monitoring device 102, using a large number of different protocols. In this manner, a wide variety of inexpensive sensors 124 can be utilized with both legacy and proprietary monitoring devices 102 to offer a product having a wide range of applications and the ability to communicate over any desired communication protocol.

In prior monitoring systems, in order to provide a sensor that interfaced with a particular protocol, the sensor would have to be designed with an interface that provided data in accordance with that particular protocol. As a sensor manufacturer, there are hundreds of different protocols, so that separate sensor units would have to be both designed and placed in stock for each different type of protocol, with each different type of sensor, in order to provide a full sensor product line. Using a 1-wire protocol for connecting sensors, or other similar protocol, and utilizing smart sensors that are capable of providing information regarding the type of sensor and the identity of each of the sensors, a single interface can be provided for each of the protocols that are used by the monitoring system, whether these monitoring systems are proprietary or non-proprietary. In other words, a single interface to a monitoring system can be built to provide access by a full line of smart sensors, so that a full line of sensors can be provided by simply providing a single interface. In addition, future protocols can be accessed by the full line of sensors by, again, designing a wired or wireless interface device that matches the protocol of the smart sensors to the protocol of the monitoring device.

The high level monitoring system 152, illustrated in FIG. 1, may be a monitoring system such as disclosed in U.S. Provisional Patent Application Ser. No. 61/647,286, entitled “Facilities Management System,” filed May 15, 2012, by Donald M. Raymond and Rick Stelzer, which is specifically incorporated herein by reference for all that it discloses and teaches. Again, these high level monitoring systems provide various sophisticated functions and sophisticated displays of the collected data. The monitoring device 102 is connected to an optional wireless module 104 that provides for wireless communication between wireless interface 126 and other external communication systems, including the high level monitoring system 152, hotspot 144, and the Internet 154. The wireless module 104 includes a plurality of external antenna ports 114, which allow the wireless module 104 to communicate via one or more external antennas. Wireless module 104 also includes internal antennas for wireless communication, as explained in more detail below. Wireless module 104 also includes wireless communication ports 116. The wireless communication ports may operate on any one of a number of different protocols. The external antenna ports 114 may receive and transmit wireless signals directly to and from wireless interface devices, such as wireless interface 126, via wireless signals 130. External antennas connected to the external antenna ports may also send and receive wireless signals 146 via hotspot 144. Hardwired connection 148 may be connected to the wireless communication ports 116. The wireless communication port 116 may use commonly accepted protocols, such as USB, Ethernet, or other standard protocols. Hotspot 144 may comprise a router, or may be a hotspot 2.0 device that interfaces with mobile devices. Hotspot 2.0 devices are based on the IEEE 802.11 U standard, which utilizes a cellular connection to access the Internet, but which is based on a dynamic billing model known as the “User-Fairness-Model” that charges by the amount of data transmitted and received by the hotspot. Hotspot 144 may also comprise a satellite transceiver that connects to the Internet through a satellite signal. A satellite hotspot operates in the same manner as a cellular hotspot, but uses a satellite link, rather than a cell link, to connect to the Internet 140.

If the wireless module 104, illustrated in FIG. 1, is a legacy system that operates with a predetermined non-standard protocol, the wireless interface 126 may translate the sensor signals from sensor 132. The wireless interface 126 is designed to translate the sensor signals from sensors 132 into the protocol used by the wireless module 104, so that the wide variety of sensors 132 can be utilized with the wireless module 104. The protocols for the wireless transmission 130 can comprise any number of different protocols, including 900 MHz, Zigbee Z-wave, WiFi, Bluetooth, 2.4 GHz, 433 MHz, 418 MHz, 868 MHz and various proprietary protocols that utilize encrypted signals, frequency hopping signals, and other wireless transmitted signals. In this manner, the wireless interface 126 and sensors 132 can communicate with proprietary systems and legacy systems, either directly through the external antennas connected to external antenna ports 114 or through the hotspot 144. Cloud monitoring applications 154 may be coupled to the Internet 140 via wired or wireless connection 156. The cloud monitoring applications 154 may constitute high level monitoring systems that are able to provide a sophisticated display of the data in the manner described above.

FIG. 2 is a schematic block diagram of an embodiment of a monitoring device 102 and a wireless module 104. As illustrated in FIG. 2, the microcontroller is connected to the USB port 212 through a USB interface 220. Connector 228 connects the USB interface to the USB I/O 236 in the microcontroller 202. Similarly, RS485 port 214 is connected to a serial interface 222, which, in turn, is connected to a serial I/O port 238, in the microcontroller 202 via connector 230. The RS485 port may comprise other types of serial ports, such as high speed serial ports, RS232, 1-wire ports, or any serial protocol. Ethernet port 216 is connected to an Ethernet interface 224 in the monitoring device 102. Connector 232 connects the Ethernet interface 224 to the Ethernet input/output port 240 of the microcontroller 202. Various other ports can be included on the monitoring device 102, so that the monitoring device 102 may be compatible with other standard communication protocols. The plurality of wired sensor ports 218 are connected to a serial interface 226 on the monitoring device 102. The serial interface 226 is connected to the serial input/output port 242 by connector 234. The protocol for the serial I/O may be any desired serial protocol, including UART, I²C, FireWire, high speed serial connections, etc. In this manner, the sensors can be connected directly to the monitoring device 102. A microcontroller can also be connected to random access memory 204 and flash memory 206 to increase the memory capability of the monitoring device 102. Monitoring device 102 may also include a display 208 that is controlled by the microcontroller 202, so that collected data can be displayed directly on the monitoring device 102. As also shown in FIG. 2, communication port 210 connects the microcontroller 202 and the monitoring device to the microcontroller 212 and the wireless module 104.

As also shown in FIG. 2, communication port 210 may comprise a high speed serial communication port to transfer data between microcontroller 202 and microcontroller 212. The microcontroller 212 that is part of the wireless module 104 is connected to the antenna ports 114 and the wireless communication ports 116. In addition, the high level monitoring system 152 and the cloud monitoring applications 154 are also connected to the wireless module 104.

FIG. 3 is a schematic diagram of another embodiment of a monitoring device 102 and a wireless module 104, illustrating one manner of assembling components of the monitoring device 102 and wireless module 104. As illustrated in FIG. 3, the monitoring device 102 may include an energy harvester/battery pack 302. The energy harvester/battery pack 302 may be an energy harvester or a battery pack, or a combination of an energy harvester and a battery pack that plug into the monitoring device 102. Energy harvesting devices may include RF energy harvesters, vibration energy harvesters, solar or light collectors, or other devices. In addition, the energy harvester/battery pack 302 may include batteries that can be charged by the energy harvesting portion of the energy harvester/battery pack 302. In addition, the pack 302 may include just batteries to operate the monitoring device 102 and wireless module 104. The pack 302 is arranged so that the pack 302 may be inserted and removed from the monitoring device 102 and is accessible from the outside of the monitoring device 102. In this manner, the pack 302 can be easily exchanged for a charged battery pack. The pack 302 can be inserted into the bus bar 304, so that connectors 320 connect with the bus bar 304.

As also shown in FIG. 3, an electronics board 306 is connected to the bus bar 304 by way of connectors 318. Electronics board 306 can simply be plugged into the bus bar 304 for connection to energy pack 302 and the optional wireless module 104. The electronics board may include one or more internal antennas 308, 310, as well as one or more patch antennas 312. The patch antenna 312 can be formed as part of the circuit board of the electronics board 306. I/O devices, such as I/O interface 314 and I/O interface 316, can also be mounted on the electronics board 306. Other electronic components can also be included on the electronics board, including interface devices for the microcontroller 202. Connector 322 is connected to connector 324, which connects the monitoring device 102 to the wireless module 104. The wireless module may be physically attached to the monitoring device 102 by way of a latch 326. The wireless module 104 includes a microcontroller 212 that is connected to the external antenna ports 114 via I/O devices 330 and wireless communication ports 116 via I/O devices 328. Sensors 332, 334 may be connected to the wired sensor ports 112, or to a wireless interface device (not shown) and subsequently to the external antenna ports 114. The sensors include connectors 336, 338, 340, 342, which may be simple RJ12 type of connectors. As such, the interconnecting wires are simple telephone cords that can be easily affixed to the RJ12 connectors. The use of easy-to-use and inexpensive connectors, such as RJ12 connectors, reduces the overall price and increases the simplicity of the overall system. The wired communication ports 110, as disclosed above, can be connected to various other devices, such as high level monitoring systems and the Internet.

FIG. 4 is a schematic block diagram of an embodiment of a monitoring and control communication system 400. As illustrated in FIG. 4, the monitoring system 414 may include both hardwired ports and antenna ports. For example, as illustrated in FIG. 4, monitoring system 414 includes an antenna 416, which communicates wirelessly with repeater 410 and wireless transceiver 402 via antennas 412, 406, respectively.

Alternatively, WiFi router 424 can be connected by wire 425 to the monitoring system 414, or may be wirelessly connected via wireless link 428 between antenna 416 of monitoring system 414 and antenna 426 of the WiFi router 424. Further, WiFi router 424 may be connected directly to the Internet 430 via link 438. Link 438 may allow the monitoring system 414 to connect to the Internet, rather than via link 432. WiFi router 424 may also comprise a hotspot device that links the monitoring system 414 to the Internet 430. In this manner, the data collected by sensors, such as sensor 404, which are interconnected by wires 403, 405 to the wireless interface 402, can be transmitted in several different ways to the monitoring system 414 and to the Internet 430. Again, the monitoring system 414 can be directly coupled to the Internet 430 via link 432, or data can be transferred wirelessly through link 428 via router 424 to the Internet 430. The controls and notification device 434 is also connected via link 436 to the Internet 430. Controls and notification device 434 may be a higher level monitoring device, such as higher level monitoring system 152, or may be a web-based program that provides notification to users and data which can be accessed toy the users.

FIG. 5 is another embodiment of a monitoring and control communication system 500. As illustrated in FIG. 5, the monitoring system 502 may be wirelessly linked to a wireless interface 516 via wireless link 510 that communicates through the monitoring system antenna 504 and the wireless interface antenna 518. Wireless interface 516 may also wirelessly connect to the monitoring system 502 via wireless link 550 between wireless interface antenna 518 and hotspot antenna 546. Hotspot 542 is connected via link 544 to the monitoring system 502, as illustrated in FIG. 5. Hotspot 542 may be either hardwired, or wirelessly linked, to the Internet 534 via link 548. If link 548 is a wireless link, hotspot 542 may be a cellular link to cell tower 524, or a satellite link to satellite 522. If link 548 is a hardwired link, hotspot 542 may be direct wired via an Ethernet port, DSL line, or other hardwired connection 548 to the Internet 534. Monitoring system 502 may also have an antenna 506 that links directly to satellite 522 via wireless link 512. Satellite 522 is coupled to ground station 526 via wireless link 530 that communicates to the ground station antenna 528. Ground station 526 is connected to the Internet via link 532. Monitoring system 502 can also be directly connected to a cell system via wireless link 514 between antenna 508 of the monitoring system 502 and the cell tower 524. The cell tower 524 may be connected to the Internet via wireless link 536 to central office 537. Accordingly, the monitoring system 502 can alternatively be connected to the Internet 534 via various wired and wireless links. In this manner, data from sensors, such as sensor 520, can be communicated to the wireless interface 516 where the data is translated into a protocol for communication to the monitoring system 502 via wireless link 510. Similarly, wired interface 552 connects through a wired link 554 to the monitoring system 502 to transmit data that has been translated to a desired protocol from sensor 556. Controls and notification device 538 is connected to the Internet via link 540, which may be either a wired or wireless link. The controls and notification may be a higher level monitoring system or may be a web-based system that notifies users and provides data for display.

FIG. 6 is a schematic block diagram of an embodiment of a wired interface system 600. The wired interface system 600 has a plurality of sensors 634, 636 that are connected via wires 624, 628, 630 to a wired interface 604. Connectors 612, 614, 616, 618, 620 provide inexpensive and easy to use connectors for connecting the sensors 634, 636 to each other and to the wired interface 604. For example, the connectors 612-620 may be RJ12 connectors and the wires 624-630 may be simple telephone wires. RJ12 connectors are easily attached to telephone wire. In addition, the connectors and the wires are very inexpensive. Similarly, the connectors 608, 610 can also be RJ12 connectors and the wire 622 can be telephone wire. Wired interface 604 includes a microcontroller 632. Wired interface 604 is connected to a monitoring system, which may be a custom monitoring system that uses a non-standard protocol, or a proprietary protocol, for connecting to sensors. Alternatively, monitoring system 602 may be a monitoring system that uses standard protocols for receiving signals from sensors 634, 636. The microcontroller 632 is programmed to translate the data received from sensors 634, 636 to a protocol that is utilized by the monitoring system 602. For example, 1-wire protocol may be used by the sensors 634, 636 to transmit a serial data stream to the wired interface 604. The 1-wire protocol is a serial protocol that uses a single data line, plus ground reference, for communication. The microcontroller 632 functions as a master, which initiates and controls the communication with the sensors 634, 636 and additional sensors which function as slave devices. Each 1-wire slave device has a unique, unalterable, pre-programmed 64 bit identification number, which serves as a device address on the 1-wire bus. Each sensor has an 8 bit code that identifies the particular device and its device type and functionality, such as whether the device is a humidity sensor, temperature sensor, or other type of device. Typically, 1-wire slave devices operate over a voltage range of 2.8 volts minimum to 5.2 volts maximum. The 1-wire devices are powered directly from the 1-wire bus. The 1-wire bus protocol allows for a large number of sensors to be connected, as illustrated in FIG. 6. In this manner, one single wire can be used to provide a large number and wide variety of sensors that all communicate on the same protocol that are connected on a 1-wire system to the wired interface 604. Microcontroller 632 translates the 1-wire protocol data to a protocol that is used by the monitoring system 602. For example, the monitoring system 602 may use any one of a number of various protocols, such as USB, Ethernet, RS485, RS232, I²C, UART, which are standard protocols. Alternatively, some monitors use a proprietary protocol. Microcontroller 632 can translate the serial data stream to the protocol used by monitoring system 602. In this manner, a desired sensor set can be created and utilized with virtually any type of monitoring system 602 by using the wired interface 604, which is capable of translating the protocol of the data stream from the sensors to the protocol of the monitoring system 602. Of course, 1-wire is only one example of a protocol that can be used to connect a plurality of sensors 634, 636 using wires 624-630 and connectors 612-620. I²C and other protocols, as set forth above, can be used for this purpose.

FIG. 7 is a schematic block diagram illustrating an embodiment of a wireless interface system 700. As illustrated in FIG. 7, a plurality of sensors 728, 730 are connected together via wires 722, 724, 726 using connectors 712, 714, 716, 718, 720, and to the wireless interface 708. Wireless interface 708 functions in a manner similar to the wired interface 604 of FIG. 6 and includes a microcontroller 710. Microcontroller 710 translates the data from the sensors 728, 730 from a protocol, such as a 1-wire protocol, to the protocol of the monitoring system 702. Wireless interface 708 is connected to an antenna 706 that transmits a wireless signal to antenna 704. Monitoring system 702 receives the wireless sensor signal in a protocol that is used by the monitoring system 702. The wireless interface 708 may include a transceiver that both sends and receives signals via the antenna 706.

By using the microcontroller 710 to translate the data from a protocol that is received from the sensors, to a protocol that can be used by the monitoring system 702, economies of scale can be realized, since the sensors 728-730 can be made on a large scale and utilized with all different types of monitoring systems, since the wireless interface 708 renders the sensors 728, 730 compatible with all different types of monitoring systems. The sensors 728-730, as well as the wireless interface 708, can be manufactured on a mass scale at a fraction of the cost of these devices when manufactured on a small scale. Large scale manufacturing can reduce the price of the wireless interface 708, sensors 728-730, wired interface 604, and sensors 634, 636 to less than one-fifth of the cost of these devices when manufactured in small scale runs. Sensors 634, 636 can be the same sensors as sensors 728, 730 and can be utilized either in a wired or wireless system. Microcontrollers 632, 710 may comprise field programmable gate arrays (PGAs) that can be field programmed for translating different protocols. In this manner, the wireless interfaces 604, 708 can be manufactured in large scale, without being tied to any particular protocols, and then programmed to translate desired protocols.

FIG. 8 is a schematic block diagram of an embodiment of a sensor 800. The sensor 800 has two connectors 802, 804. Detector 806 detects the particular environmental condition that is to be sensed by the sensor 800. For example, detector 806 may sense humidity, temperature, or any desired environmental condition. Detector 806 may also be a detector that detects the presence of people, animals, objects or other things to be detected. The detector 806 generates a signal that is received by the microcontroller 810. The microcontroller 810 conditions the signal and generates the signal in a particular protocol, which is transmitted to the serial interface 812. The serial interface 812 is connected to connectors 802, 804 and the serial signal is transmitted to the connectors 802, 804. As shown in FIG. 8, signals can be transmitted from one sensor to another and a serial signal can be generated containing data from each sensor in a serial data stream. Alternatively, the data can also be transmitted in any desired fashion, including a parallel data stream. The microcontroller 810 generates data that contains an identification of the sensor 800 and the type of signal that is being transmitted, i.e., temperature, humidity, etc. As such, sensor 800 is considered to be an intelligent sensor. In this fashion, the monitoring device can identify the particular sensor and the type of signal being sensed.

Embodiments of the present invention therefore provide a monitoring system for monitoring a wide range of environmental conditions, which can be communicated either by wired or wireless connections. These systems can be connected to higher level monitoring devices or web based systems to provide alarms, notifications and a presentation of the data to users. The sensors can be mass manufactured at lower costs and provide a wide variety of sensing functions. Both wired and wireless interface devices are utilized to translate the protocol of the collected data from the sensors to a protocol that can be recognized and utilized by a standard or proprietary monitoring system. In this manner, the mass produced sensors can be utilized with virtually any monitoring system, which greatly reduces costs and increases the variety of sensors that can be utilized with various monitoring systems.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A sensor system comprising:
at least one sensor that generates a sensor signal using a first predetermined communication protocol;
an interface translator that translates said sensor signal from said first predetermined communication protocol to a second communication protocol that is used by a monitoring system.

2. The sensor system of claim 1 wherein said interface translator is a wireless interface.

3. The sensor system of claim 1 wherein said interface translator is a wired interface.

4. The sensor system of claim 1 wherein said at least one sensor comprises a plurality of sensors that are connected to generate a serial sensor signal.

5. A method of sensing environmental conditions comprising:
connecting a plurality of sensors in series that generate a serial sensor signal;
transmitting said serial sensor signal to an interface translator;
translating said serial sensor signal to a monitor sensor signal that is capable of being read by a monitoring device.

6. The method of claim 5 wherein said process of connecting said plurality of sensors comprises connecting said sensors in series to a wireless interface translator.

7. The method of claim 5 wherein said process of connecting a plurality of sensors comprises connecting said sensors in series to a wired interface translator.

8. A monitoring system comprising:
a monitoring device that has at least one wired sensor port that receives signals using a first communication protocol;
a plurality of sensors that are connected in series that generate a serial sensor signal that uses a second communication protocol;
a direct wired interface that is connected to said plurality of sensors and said at least one wired sensor port that translates said serial sensor signal from said second communication protocol to said first communication protocol.

9. The monitoring system of claim 8 further comprising:
a high level monitoring system that is connected to a wired communication port on said monitoring device.

10. A monitoring system comprising:
a monitoring device;
a wireless module that is connected to, and communicates with, said monitoring device using a first communication protocol, said wireless module having at least one wireless communication port that sends and receives wireless transmissions using said first communication protocol;
a plurality of sensors that are connected in series that generate a serial sensor signal using a second communication protocol;
a wireless interface that is connected to said plurality of sensors and to said at least one wireless communication port that translates said serial sensor signal from said second communication protocol to said first communication protocol.

11. The monitoring system of claim 10 further comprising:
a hotspot that provides a wireless communication link for said wireless module and said wireless interface.

12. A method of monitoring sensor signals comprising:
connecting a plurality of sensors in series to generate a serial sensor signal having a first communication protocol that identifies serially connected sensors, data generated by each sensor of said serially connected sensors and a type of data that is detected by each said sensor;
transmitting said serial sensor signal to an interface translator;
translating said serial sensor signal from said first communication protocol to a second communication protocol;
transmitting said serial sensor signal having said second communication protocol to a monitoring device that can read said second communication protocol.

13. The method of claim 12 wherein said process of transmitting said serial sensor signal to said monitoring device comprises wirelessly transmitting said serial sensor signal to said monitoring device.

14. The method of claim 12 wherein said process of transmitting said serial sensor signal to said monitoring device comprises transmitting said serial sensor signal over a hardwired connection to said monitoring device.

15. The method of claim 12 wherein said communication protocol is a non-proprietary protocol that is commonly used by monitors.

16. The method of claim 12 wherein said communication protocol is a proprietary protocol.

17. The method of claim 15 wherein said second communication protocol is a USB protocol.

18. The method of claim 12 wherein said process of connecting a plurality of sensors comprises connecting a plurality of smart sensors having identification serial numbers.
